(19) United States
(12) Patent Application Publication
(10) Pub. No.: US 2026/0180958 A1
(43) Pub. Date: Jun. 25, 2026

(54) TECHNOLOGIES FOR INTERNET PROTOCOL MULTIMEDIA SUBSYSTEM SECURITY

(71) Applicant: Apple Inc., Cupertino, CA (US)

(72) Inventors: Shu Guo, Beijing (CN); Robert K. Kitchens, San Jose, CA (US); Yannick L. Sierra, San Francisco, CA (US); Haijing Hu, Los Gatos, CA (US); Dawei Zhang, Saratoga, CA (US); Delziel J. Fernandes, San Jose, CA (US); Huarui Liang, Beijing (CN); Fangli Xu, Beijing (CN)

(73) Assignee: Apple Inc., Cupertino, CA (US)

(21) Appl. No.: 18/834,996

(22) PCT Filed: Jul. 31, 2023
(86) PCT No.: PCT/CN2023/110324

§ 371 Date: Jul. 31, 2024

(51) Int. Cl. H04L 9/40; H04L 9/08

(52) U.S. Cl. CPC H04L 63/0428; H04L 9/0838; H04L 9/0869

(57) ABSTRACT

The present application relates to devices and components including apparatus, systems, and methods for Internet Protocol multimedia subsystem security.

### BACKGROUND

Internet Protocol multimedia subsystem (IMS) is a system that resides out of an access network and is connected to a long-term evolution (LTE) or a new radio (NR) network through a packet data network (PDN) or user plane function (UPF). The IMS may allow for services such as text, multimedia messages, and voice calls to be correctly delivered through an IP network.

### BRIEF DESCRIPTION OF THE DRAWINGS

FIG. 1 illustrates a network environment in accordance with some embodiments.

FIG. 2 illustrates a security architecture in accordance with some embodiments.

FIG. 3 illustrates an encryption process in accordance with some embodiments.

FIG. 4 illustrates an example signaling procedure in accordance with some embodiments.

FIG. 5 illustrates an operation flow/algorithmic structure in accordance with some embodiments.

FIG. 6 illustrates a device in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); the phrase “(A)B” means (B) or (A and B), that is, A is optional; and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated.

Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

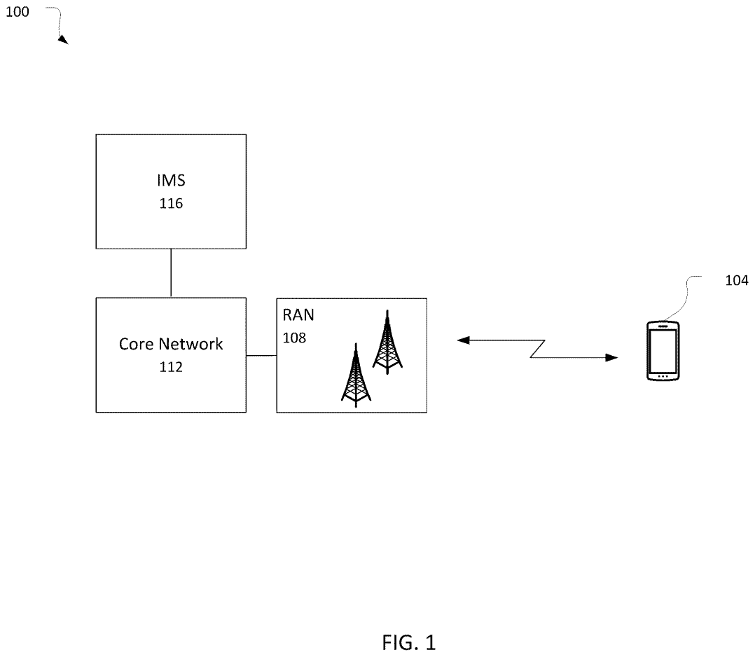

FIG. 1 illustrates a network environment 100 in accordance with some embodiments. The network environment 100 may include a UE 104 communicatively coupled with one or more base stations of a radio access network (RAN) 108. The UE 104 and the base stations of the RAN 108 may communicate over air interfaces compatible with Third Generation Partnership Project (3GPP) Technical Specifications (TSs) such as those that define LTE, NR, or later system standards. The base station 108 may be an evolved node B (eNB) to provide one or more LTE cells or a next generation node B (gNB) to provide one or more fifth generation (5G) (or later) New Radio (NR) cells.

The network environment 100 may further include a core network (CN) 112 coupled to the RAN 108 via a backhaul (for example, a fiber optic or wireless backhaul). The CN 112 may provide functions for the UE 104 via the base station 108. These functions may include managing subscriber profile information, subscriber location, authentication of services, or switching functions for voice and data sessions.

The network environment 100 may further include an IMS 116 to provide IP multimedia (IM) services to the UE 104. The IM services may include, for example, voice (for example, voice-over-LTE (VOLTE) or voice-over-NR (VoNR)), video, messaging, data, and web-based services.

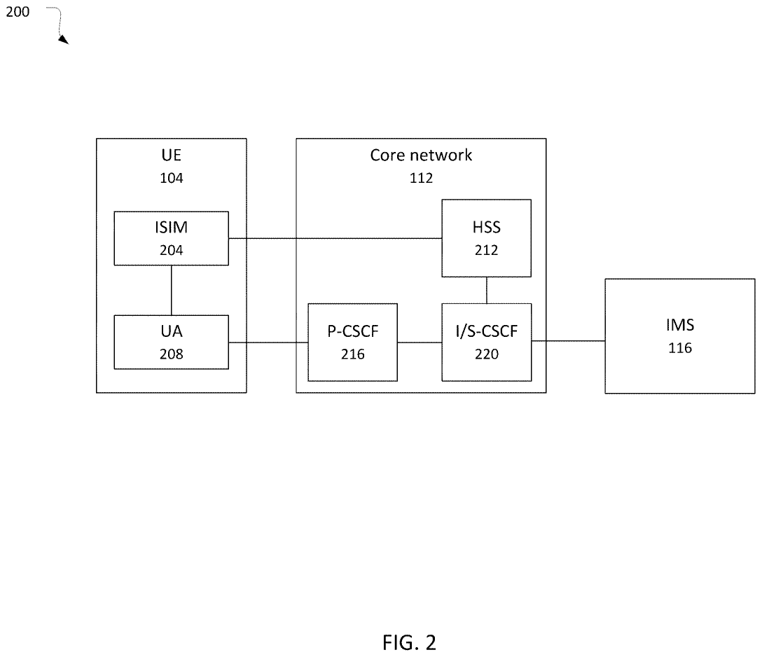

FIG. 2 illustrates an IMS security architecture 200 with respect to components of the network environment 100 in further detail in accordance with some embodiments. The IMS security architecture 200 may include an IP multimedia services identity module (ISIM) 204 and a user agent (UA) of the UE 104. The IMS security architecture 200 may further include, in the CN 104, a home subscriber server (HSS) 212, a proxy-call session control function (P-CSCF) 216, and an interrogating/serving-call session control function (I/S-CSCF) 220.

Prior to providing IMS services, one or more security associations may be established between the UE 104 and the core network 112. The security associations can include a first security association between the ISIM 204 and the HSS 212 and a second security association between the UA 208 and the P-CSCF 216.

The ISIM 204 may be implemented on a universal integrated circuit card (UICC) to perform collection of IMS security data and functions. As part of an IMS authentication and key agreement (AKA) procedure, the ISIM 204 and the HSS 212 may perform mutual authentication to obtain a long-term key that is associated with an IP multimedia private identity (IMPI). The IMPI, which may be in a network access identifier (NAI) format, may be an identity used to authenticate a subscriber. The HSS 212 may use an S-CSCF of the I/S-CSCF 220 for the subscriber authentication.

Two pairs of unilateral Internet Protocol Security (IPsec) security associations (SAs) may be established between the UA 208 and the P-CSCF 216 for each registered contact. These IPsec SAs may provide a secure link and association between the UE 104 and the P-CSCF 216 to protect a Gm reference point. These IPsec SAs may be used to ensure that the source of the data received is as claimed.

An SA for IPsec may include the following parameters: an encryption algorithm; an integrity algorithm; a security parameter index (SPI); a life type; an SA duration; a transport mode; a length of an integrity key (IK_ESP); a length of an encryption (or cipher) key (CK_ESP); and selectors of session initiation protocol (SIP) flows between UE and P-CSCF (e.g., IP addresses bound to two pairs of SAs, transport protocol selector (user datagram protocol (UDP) and transmission control protocol (TCP)), and ports).

Except as otherwise described herein, IMS AKA may be similar to that described in 3GPP TS 33.203 v 17.1.0 (2022-03). See, for example, clause 6.1 and 7 of TS 33.203.

Various encryption standards may be used for IPsec to protect transmissions between the UE 104 and components of the networks. In some embodiments, an Advanced Encryption Standard (AES) Galois/Counter Mode (GCM) may be used for IPsec. The AES GCM may be consistent with that defined in “The Use of Galois/Counter Mode (GCM) in IPsec Encapsulating Security Payload (ESP),” Internet Engineering Task Force (IETF), Request for Comment (RFC) 4106 (June 2005). In other embodiments, an AES Galois Message Authentication Code (GMAC) may be used for IPsec. The AES GMAC may be consistent with that defined in “The Use of Galois Message Authentication Code (GMAC) in IPsec ESP and AH,” IETF, RFC 4543 (May 2006).

When AES GCM or AES GMAC are used for IPsec, it may be desirable for the nonce supplied to the algorithm for encrypting each packet to not be repeated under the same key. To achieve this, an encryptor for an IPsec SA may generate an initialization vector (IV) for each encrypted packet that is not repeated for the lifetime of the IPsec SA. IPsec does not provide a method for peers to coordinate IV generation across SAs, so it is possible for IVs to be duplicated across multiple SAs. To ensure this does not lead to nonce reuse under the same key, a salt value may be supplied to IPsec along with the key, which is combined with each IV to form the nonce supplied to the algorithm. If two or more IPsec SAs use the same key, it is required that the salt values supplied for the SAs be different.

RFC 4543 provides that the
GCM authenticated encryption operation has four inputs: a secret key, an IV, a plaintext, and an input for additional authenticated data (AAD). It has two outputs, a cipher text whose length is identical to the plaintext and an authentication tag. GMAC is the special case of GCM in which the plaintext has a length of zero. The (zero-length) ciphertext output is ignored, of course, so that the only output of the function is the Authentication Tag. In the following, we describe how the GMAC IV and AAD are formed from the ESP and AH fields . . .
Below we refer to the AES-GMAC IV input as a nonce, in order to distinguish it from the IV fields in the packets. The same nonce and key combination MUST NOT be used more than once, since reusing a nonce/key combination destroys the security guarantees of AES-GMAC . . .
The salt SHOULD be unpredictable (i.e., chosen at random) before it is selected, but need not be secret . . .
When IKE is used to establish fresh keys between two peer entities, separate keys are established for the two traffic flows. If a different mechanism is used to establish fresh keys (one that establishes only a single key to encrypt packets), then there is a high probability that the peers will select the same IV values for some packets. Thus, to avoid counter block collisions, ESP implementations that permit use of the same key for encrypting and decrypting packets with the same peer MUST ensure that the two peers assign different salt values to the security association (SA).

According to Section 10 of RFC 4106, which describes the use of AES-GCM in IPsec ESP,
[w]hen [Internet key exchange (IKE)] is used to establish fresh keys between two peer entities, separate keys are established for the two traffic flows. If a different mechanism is used to establish fresh keys (one that establishes only a single key to encrypt packets), then there is a high probability that the peers will select the same IV values for some packets. Thus, to avoid counter block collisions, ESP implementations that permit use of the same key for encrypting and decrypting packets with the same peer MUST ensure that the two peers assign different salt values to the security association (SA).

Annex I of 3GPP TS 33.203 provides for key expansion functions that may be used for IPsec encapsulating security payload (ESP). However, the current version of Annex I specifies that all four IPsec SAs established for SIP security will use the same salt value. This violates the above security requirement of RFCs 4106 and 4543 and can lead to nonce re-use under the same key. Embodiments of the present disclosure describe a salt generation procedure that will avoid nonce re-use under the same key. Further, embodiments provide aspects to ensure backward compatibility.

Referring again to FIG. 2, two pairs of unidirectional SAs established between the UE 104 and the P-CSCF 216, shared by TCP and UDP, may be established in the P-CSCF 216 and, later, in the UE 104. One SA pair, referred to herein as {SA1a, SA1b} may be used for traffic between a client port at the UE 104 and a server port at the P-CSCF 216.

The other SA pair, referred to herein as {SA2a, SA2b}, may be used for traffic between a client port at the P-CSCF 216 and a server port at the UE 104. The two SAs in one pair may be used for ESP or authentication header (AH) separately.

An integrity key (IK_ESP) may be the same for the two pairs of simultaneously established SAs. Similarly, an encryption key (CK_ESP) may be the same for the two pairs of simultaneously established SAs. The CK_ESP and IK_ESP may be obtained from keys CK_IM and IK_IM established as a result of an AKA procedure.

A salt value may be derived together with the CK_ESP and IK_ESP. As discussed above, requirements for AES GMAC in RFC 4543 and RFC4106 included that “the same nonce and key combination MUST NOT be used more than once.” Thus, embodiments describe that, when using the same CK_ESP and IK_ESP for different SAs, the salt values may be different. A number of different embodiments are described to generate these unique salt values to be used for different SAs. Further, embodiments describe negotiation procedures to address backward compatibility issues.

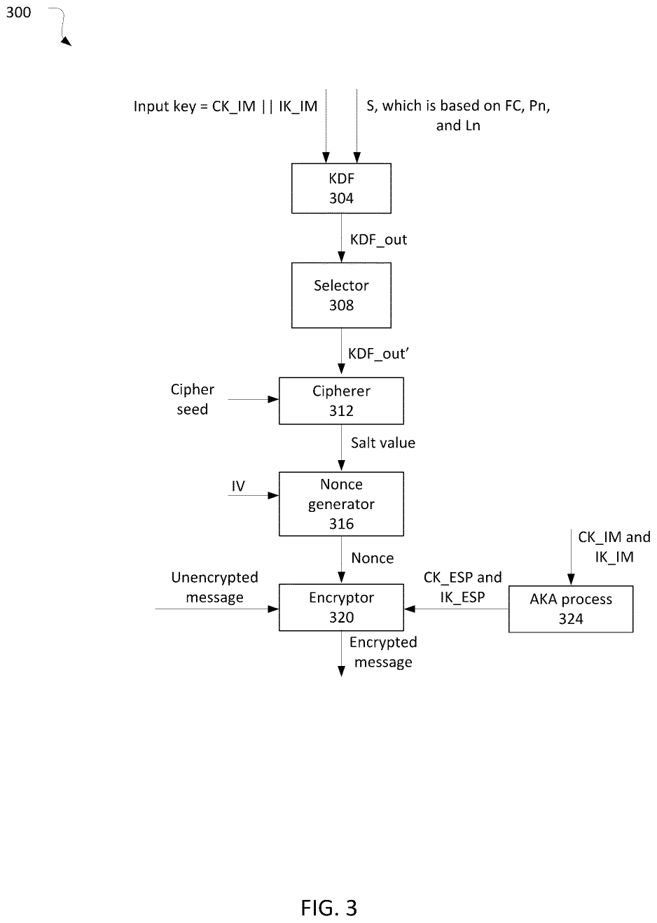

FIG. 3 illustrates an encryption process 300 in accordance with some embodiments. The encryption process 300 may be performed by various modules/functions provided by a device such as, for example, the UE 104 or the P-CSCF 216.

The encryption process 300 may include a key derivation function (KDF) 304 receiving two inputs and generating a derived key (KDF_out). A first input may be an input key that is based on CK_IM and IK_IM. In some embodiments, the input key may be equal to a concatenation of CK_IM and IK_IM, for example, CK_IM∥IK_IM. A second input, referred to as a string(S), may be based on three parameters. A first parameter, which may be referred to as a function code (FC), may be used to distinguish between different instances of an algorithm. The FC may be a single octet or may include two octets of the form FC1∥FC2, where FC1=0xFF and FC2 is a single octet. In some embodiments, FC=0x58. A second parameter may be an input parameter encoding (Pn). A first input parameter encoding, P0, may be a static ASCII-encoded string such as, for example, “AES_GMAC_SALT.” The third parameter may be eight two-octet representation of a length of a corresponding input parameter encoding (Ln). For example, if P0 is a string “AES_GMAC_SALT,” then L0 may be a length of the string (e.g., 0x000x0D). In some embodiments, S may be given by: S=FC ∥P0∥L0∥P1∥L1∥P2∥L2∥ . . . ∥Pn∥Ln. In general, except as otherwise described herein, the KDF 304 may generate the derived key consistent with the KDF procedures described in Annex B of 3GPP TS 33.220 v 18.0.0(2023-06-22).

The encryption process 300 may further include a selector 308 that selects a portion of the derived key. The selected portion may be referred to as KDF_out′.

The encryption process 300 may further include a cipher 312 generating a salt value based on KDF_out′, received from the selector 308, and a cipher seed. The salt value may, except as otherwise described herein, be similar to the salt value specified in section 3.2 of the RFC 4543.

The encryption process 300 may further include a nonce generator 316 generating a nonce based on the salt value, received from the cipherer 312, and an IV.

The encryption process 300 may further include an encryptor 320 generating an encrypted message based on the nonce, an unencrypted message, and a pair of ESP keys. The pair of ESP keys may include the ESP integrity key (IK_ESP) and the ESP encryption key (CK_ESP).

An AKA process 324 may generate the IK_ESP and the CK_ESP based on IM integrity key (IK_IM) and IM encryption key (CK_IM). If the AKA process 324 uses a hash-based message authentication code (HMAC)-based authentication algorithm (for example, HMAC-SHA-1-96), then IK_ESP may be obtained from IK_IM by appending 32 zero bits to an end of the IK_IM to create a 160-bit string in accordance with some examples. See, for example, IETF RFC 2404, “The Use of HMAC-SHA-1-96 within ESP and AH,” November 1998. If the AKA process 324 uses AES-GMAC as the authentication algorithm with a 128-bit key, as specified in RFC 4543, for example, then IK_ESP=IK_IM.

Generating unique salt values for different SAs, and addressing backward compatibility, may be described with respect to the encryption process 300 according to one or more the following aspects. Implementation of one or more the following aspects may be facilitated by modifying the key expansion functions (and integrity key definition) for IPsec ESP as defined in, for example, Annex I of TS 33.203.

In a first aspect, the salt value for each IPsec SA may be obtained using an SA's SPI as the cipher seed provided to the cipherer 312. For example, the KDF_out′ may be the 32 least-significant bits of the 256 bits of the KDF_out and the SA's SPI may be represented as a 32-bit integer in network byte order. In some embodiments, the cipherer 312 may perform an XOR operation on the KDF_out′ and the SA's SPI.

In a second aspect, the encryption process 300 may be modified by removing the cipherer 312 and generating a plurality of salt values. For example, a first salt value may be derived using the KDF 304 as described above, but with a first set of input parameters (e.g., P0=“AES_GMAC_SALT_NONCE1” and L0=length of the string “AES_GMAC_SALT_NONCE1”) to generate a first KDF_out. The first KDF_out′, which may be the 32 least significant bits of the first KDF_out, may correspond to the first salt value. A second salt value may be generated by using another run of the KDF 304 with a second set of input parameters (e.g., P0=“AES_GMAC_SALT_NONCE2” and L0=length of the string “AES_GMAC_SALT_NONCE2”) to generate a second KDF_out. The second KDF_out′, which may be the 32 least significant bits of the second KDF_out, may correspond to the second salt value. NONCE1 and NONCE2 may be configured by implementation. In this manner, salt values may be refreshed for different messages for the same key.

In a third aspect, the cipher seed may be a NONCE value. With this aspect, the cipherer 312 may generate the salt value by performing an XOR operation based on KDF_out′, for example, the 32 least significant bits of the 256 bits of KDF_out, and a NONCE. The NONCE may be configured through implementation. In some embodiments, every single salt value may be generated using a different NONCE.

In a fourth aspect, the cipher seed may be a two-bit value that indicates a role and direction for a sending side of the SA. For example, a first bit of the two-bit value may correspond to a direction (for example, ‘0’ indicates a direction from the UE 104 to the P-CSCF 216 and ‘1’ indicates a direction from P-CSCF 216 to the UE 104). A second bit of the two-bit value may correspond to a role (for example, a ‘0’ indicates a client role and a ‘1’ indicates a server role).

The cipherer 312 may generate the salt value by concatenating or XOR'ing the 2-bit cipher seed with the KDF_out′. For example, in some embodiments, the KDF_out′ may be the 30 least significant bits of the 256-bit KDF_out. In this example, the cipherer 312 may concatenate the 30-bit KDF_out′ with the 2-bit cipher seed. In another example, the KDF_out′ may be the 32 least significant bits of the 256-bit KDF_out and the cipherer 312 may XOR the KDF_out′ with the 2-bit cipher seed.

In a fifth aspect, the encryption process 300 may be modified to remove the cipherer 312 and the selector 308 may affect the unique salt generation. For example, the 128 least significant bits of the 256-bit KDF_out may be divided into four 32-bit values (e.g., KDF_out′_1, KDF_out′_2, KDF_out′_3, and KDF_out′_4). A salt value for each SA may correspond to one of the four 32-bit values. For example, a salt value for SA_1a may be set equal to KDF_out′_1, a salt value for SA_1b may be set equal to KDF_out′_2, a salt value for SA_2a may be set equal to KDF_out′_3, and a salt value for SA_2b may be set equal to KDF_out′_4. The mapping from the different KDF_out′ values to the different SAs may be done by implementation or otherwise predetermined.

In some embodiments, the cipherer 312 may be omitted from the encryption process used for the fifth aspect. In other embodiments, the cipherer 312 may be included and the cipher seed may be a 2-bit value that provides the mapping from the different KDF_out′ values to the different SAs. The 2-bit value may be used with the KDF_out′ to generate the salt value in a manner similar to that described above with respect to the fourth aspect. For example, the cipherer 312 may generate the salt value by concatenating or XOR'ing the 2-bit cipher seed with the KDF_out′ that corresponds to a particular SA.

In a sixth aspect, the encryption process 300 may be modified by removing the cipherer 312 and ensuring the unique salt value by adjusting an input parameter of S. For example, in some embodiments, PO may be generated by concatenating a static ASCII text string with a string that represents a destination. For example, P0 may be set equal to “AES_GMAC_SALT”∥<string representing destination>, where <string representing destination> may be a UE client port (port_uc), UE server port (port_us), P-CSCF client port (port_pc), or P-CSCF server port (port_ps) echoing the notation used in TS 33.203. In this embodiment, the L0 value, which corresponds to the length of the string P0, may be 0x00 0x12.

Clause 7.2 of TS 33.203 provides that a UE contains a list of identifiers for integrity and encryption algorithms supported by the UE in a SIP message 1 message (SM1), which may also be referred to as a register message. The SA negotiation procedure may reuse RFC 3329 with some modifications shown in Annex H of TS 33.203. To ensure backward compatibility, a seventh aspect of the disclosure provides that, when the UE 104 supports an encryption algorithm utilizing SA-specific salt-value derivation as taught, for example, in one or more of the first six aspects of the present disclosure, the UE 104 may provide an indication of said support in the SM1. A legacy UE may not provide an indication of this support. Thus, only an updated S-CSCF receiving the SM1 with the support indication will choose an algorithm value with the SA-specific salt-value derivation as described herein.

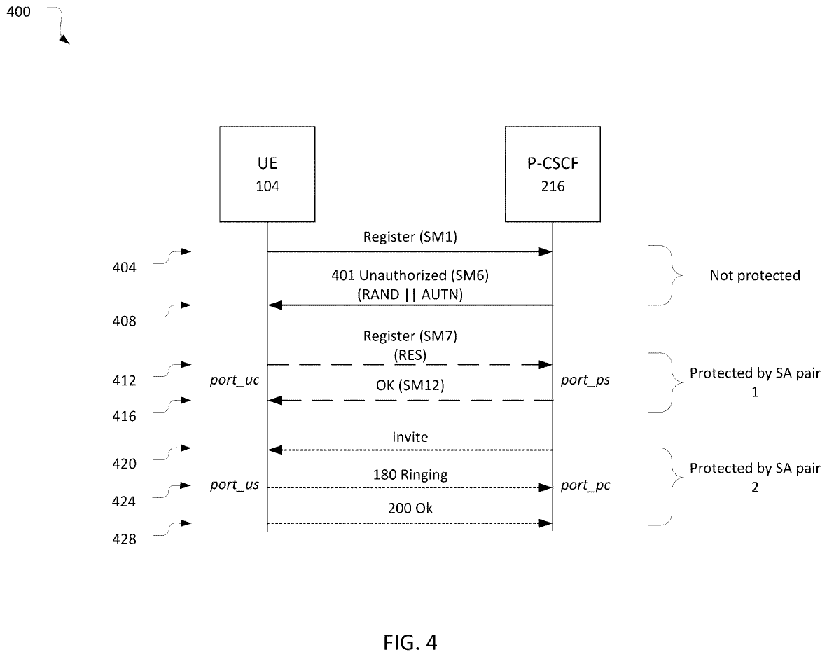

FIG. 4 illustrates an example signaling procedure 400 utilizing the pairs of SAs in accordance with some embodiments. The signaling procedure 400 may take place between the UE 104 and the P-CSCF 216.

A first unprotected, message exchange may take place between the UE 104 and the P-CSCF 216. The first message exchange may include the UE 104 sending a Register (SM1) message to the P-CSCF 216. The SM1 may include SPI values associated with client/server ports of the UE and may also include a list of identifiers for integrity and encryption algorithms supported by the UE 104. The P-CSCF 216 may respond with a 401 Unauthorized (SM6) message, which may be a concatenation of a random number (RAND) an authentication token (AUTN).

The UE 104 and the P-CSCF may establish a pair of SAs consistent with embodiments described elsewhere herein. A first pair may include a first SA to protect messages transmitted from a client port (port_uc) of the UE 104, and a second SA to protect messages transmitted from a server port (port_ps) of the P-CSCF 216. A second pair may include a first SA to protect messages transmitted from a server port (port_us) of the UE 104, and a second SA to protect messages transmitted from a client port (port_pc) of the P-CSCF 416.

After the initial exchange, with the UE 104 acting in a client role, the UE 104 may transmit, via port_uc, a first protected message (for example, a Register (SM7) message) to the P-CSCF 216 using the first SA of the first pair. The P-CSCF 216 may respond by transmitting, via port_ps, a second protected message (for example, an OK (SM12) message) to the UE 104 using the second SA of the first pair.

With the P-CSCF 216 acting in a client role, the P-CSCF 216 may transmit, via port_pc, a first protected message (for example, an Invite message) to the UE 104 using a first SA of the second pair. The UE 104 may respond by transmitting, via port_us, protected messages (for example, 180 Ringing and 200 OK messages) to the P-CSCF 216 using the second SA of the second pair.

The messages transmitted by the UE 104 through port_uc or port_us and by the P-CSCF 216 through port_ps or port_pc may be encrypted by the encryption process 300 described with respect to FIG. 3.

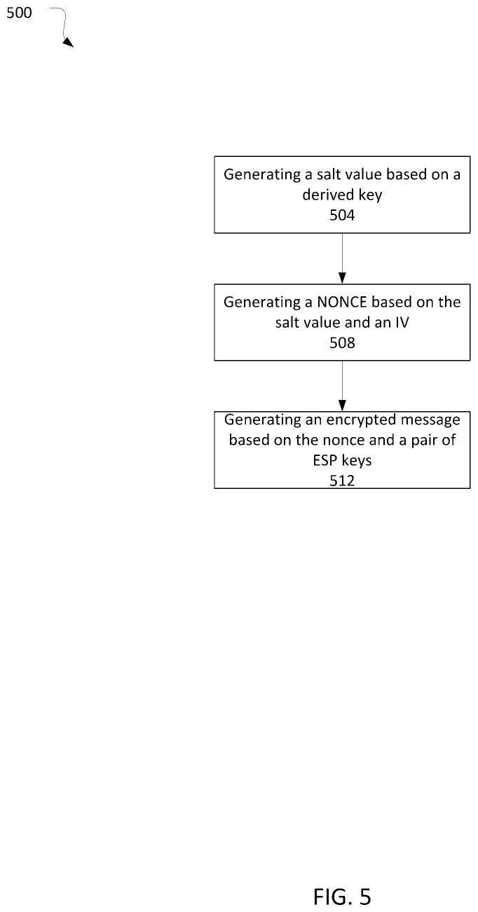

FIG. 5 is an operation flow/algorithmic structure 500 in accordance with some embodiments. The operation flow/algorithmic structure 500 may be implemented in a device such as, for example, the UE 104 or the P-CSCF 216, or components thereof, for example, processors 704.

The operation flow/algorithmic structure 500 may include, at 504, generating a salt value based on a derived key and a cipher seed. In some embodiments, the salt value may be generated based on a selected portion of the derived key. For example, the derived key may be a 256-bit key, while the selected portion used to generate the salt value may be a 32-bit portion of the 256-bit key. In some embodiments, the 32-bit portion may be the 32 least significant bits; however, in other embodiments other portions may be used.

The derived key may be generated by a key derivation function based on a plurality of input parameters. The input parameters may include an input key and a string.

The input key may be a concatenation of CK_IM and IK_IM and the string may be based on FC, Pn, and Ln as described elsewhere herein.

The operation flow/algorithmic structure 500 may further include, at 508, generating a nonce based on the salt value and an IV.

The operation flow/algorithmic structure 500 may further include, at 512, generating an encrypted message based on the nonce and a pair of ESP keys. The ESP keys may include a CK_ESP and an IK_ESP, which may be generated from CK_IM and IK IM.

In some embodiments, operation flow/algorithmic structure 500 may generate a unique salt value for an SA by generating the salt value based on both the derived key and a cipher seed. The cipher seed may be an SA security parameter index and the salt value may be generated by performing an XOR operation on the 32 least significant bits of the derived key and the SA SPI, wherein the SA SPI is represented as a 32-bit integer.

In other embodiments, the cipher seed may be a nonce, which may be changed for different salt values, or a two-bit value that indicates a role of a transmitting device (e.g., server role or client role) and a direction (for example, to the UE 104 or the P-CSCF 216)

In some embodiments, operation flow/algorithmic structure 500 may generate unique salt values for SAs by generating a plurality of strings used as an inputs to the KDF. For example, a first string may be generated based on first input parameters (e.g., P0=“AES_GMAC_SALT_NONCE1” and L0=length of the string “AES_GMAC_SALT_NONCE1”) and a second string may be generated based on second input parameters (e.g., P0=“AES_GMAC_SALT_NONCE2” and L0=length of the string “AES_GMAC_SALT_NONCE2”). These two strings may be used to generate two salt values.

In some embodiments, operation flow/algorithmic structure 500 may generate unique salt values for SAs by selecting different portions of the derived key to generate salt values for different SAs. For example, the 32 least significant bits of the derived key may be used to generate a first salt value for a first SA, then next 32 least significant bits of the derived key may be used to generate a second salt value for a second SA, and so on.

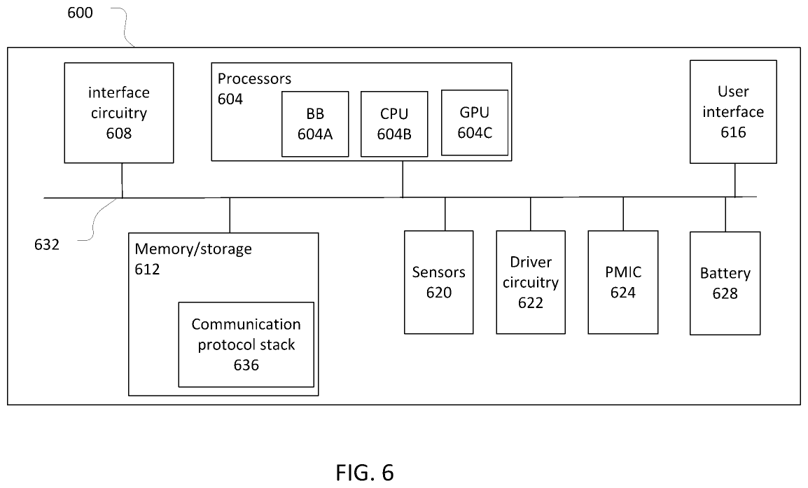

FIG. 6 illustrates a device 600 in accordance with some embodiments. The device 600 may be similar to and substantially interchangeable with UE 104 or P-CSCF 216.

The device 600 may be any mobile or non-mobile computing device, such as, for example, mobile phones, computers, servers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The device 600 may include processors 604, interface circuitry 608, memory/storage 612, user interface 616, sensors 620, driver circuitry 622, power management integrated circuit (PMIC) 624, and battery 628. The components of the device 600 may be implemented as integrated circuits (ICs), portions thereof, discrete electronic devices, or other modules, logic, hardware, software, firmware, or a combination thereof. The block diagram of FIG. 6 is intended to show a high-level view of some of the components of the device 600. However, some of the components shown may be omitted, additional components may be present, and different arrangement of the components shown may occur in other implementations.

The components of the device 600 may be coupled with various other components over one or more interconnects 632, which may represent any type of interface, input/output, bus (local, system, or expansion), transmission line, trace, or optical connection that allows various circuit components (on common or different chips or chipsets) to interact with one another.

The processors 604 may include processor circuitry such as, for example, baseband processor circuitry (BB) 604A, central processor unit circuitry (CPU) 604B, and graphics processor unit circuitry (GPU) 604C. The processors 604 may include any type of circuitry or processor circuitry that executes or otherwise operates computer-executable instructions, such as program code, software modules, or functional processes from memory/storage 612 to cause the device 600 to perform operations as described herein (such as those described with respect to encryption process 300 or operation flow/algorithmic structure 500, for example).

In some embodiments, the baseband processor circuitry 604A may access a communication protocol stack 636 in the memory/storage 612 to communicate over a 3GPP compatible network. In general, the baseband processor circuitry 604A may access the communication protocol stack 636 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the interface circuitry 608.

The baseband processor circuitry 604A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 612 may include one or more non-transitory, computer-readable media that includes instructions (for example, communication protocol stack 636) that may be executed by one or more of the processors 604 to cause the device 600 to perform various operations described herein. The memory/storage 612 include any type of volatile or non-volatile memory that may be distributed throughout the device 600. In some embodiments, some of the memory/storage 612 may be located on the processors 604 themselves (for example, L1 and L2 cache), while other memory/storage 612 is external to the processors 604 but accessible thereto via a memory interface. The memory/storage 612 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The interface circuitry 608 may a radio-frequency (RF) interface having transceiver circuitry and radio frequency front module (RFEM) that allows the device 600 to communicate with other devices over a radio access network. The RF interface may include various elements arranged in transmit or receive paths. These elements may include, for example, switches, mixers, amplifiers, filters, synthesizer circuitry, and control circuitry. The interface circuitry 608 may additionally/alternatively include other network interface to communicate via other wired or wireless networks, for example, an Ethernet interface.

The user interface 616 includes various input/output (I/O) devices designed to enable user interaction with the device 600. The user interface 616 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the device 600.

The sensors 620 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 622 may include software and hardware elements that operate to control particular devices that are embedded in the device 600, attached to the device 600, or otherwise communicatively coupled with the device 600. The driver circuitry 622 may include individual drivers allowing other components to interact with or control various input/output (I/O) devices that may be present within, or connected to, the device 600. For example, driver circuitry 622 may include a display driver to control and allow access to a display device, a touchscreen driver to control and allow access to a touchscreen interface, sensor drivers to obtain sensor readings of sensors 620 and control and allow access to sensors 620, drivers to obtain actuator positions of electro-mechanic components or control and allow access to the electro-mechanic components, a camera driver to control and allow access to an embedded image capture device, audio drivers to control and allow access to one or more audio devices.

The PMIC 624 may manage power provided to various components of the device 600. In particular, with respect to the processors 604, the PMIC 624 may control power-source selection, voltage scaling, battery charging, or DC-to-DC conversion.

In some embodiments, the PMIC 624 may control, or otherwise be part of, various power saving mechanisms of the device 600 including DRX as discussed herein.

A battery 628 may power the device 600, although in some examples the device 600 may be mounted deployed in a fixed location, and may have a power supply coupled to an electrical grid. The battery 628 may be a lithium ion battery, a metal-air battery, such as a zinc-air battery, an aluminum-air battery, a lithium-air battery, and the like. In some implementations, such as in vehicle-based applications, the battery 628 may be a typical lead-acid automotive battery.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 comprises: generating a salt value based on a derived key from a key derivation function and a cipher seed; generating a nonce based on the salt value and an initialization vector; and generating an encrypted message based on the nonce and a pair of encapsulating security payload (ESP) keys.

Example 2 includes the method of example 1 or some other example herein, wherein the cipher seed is a security association (SA) security parameter index (SPI).

Example 3 includes method of example 2 or some other example herein, wherein generating the salt value comprises: performing an XOR operation based on 32 least significant bits of the derived key and the SA SPI, wherein the SA SPI is represented as a 32-bit integer.

Example 4 includes the method of example 2 or some other example herein, wherein the salt value is a first salt value for the SA, the derived key is a first derived key, the nonce is a first nonce, and the method further comprises: generating a first string (S_1) based on a first plurality of input parameters; generating the first derived key based on the first string; and generating a second string (S_2) based on a second plurality of input parameters; generating a second derived key based on the second string; and generating a second salt value for the SA based on the second derived key and the SA SPI.

Example 5 includes the method of example 1 or some other example herein, wherein the pair of ESP keys include an ESP encryption key (CK_ESP) and an ESP integrity key (IK_ESP) and the method further comprises: generating the CK_ESP and the IK_ESP by performing an authentication and key agreement (AKA) procedure based on an Internet protocol multimedia (IM) cipher key (CK_IM) and an IM integrity key (IK_IM).

Example 6 includes the method of example 1 or some other example herein, wherein the cipher seed is a nonce.

Example 7 includes the method of example 6 or some other example herein, wherein the nonce is a first nonce, the SA is a first SA, the salt value is a first salt value for the first SA, and the method further comprises: generating a second salt value for a second SA based on a second nonce.

Example 8 includes the method of example 1 or some other example herein, further comprising: generating a register message with an identifier to indicate user equipment (UE) support for an encryption algorithm utilizing SA-specific salt-value derivation.

Example 9 includes the method of example 8 or some other example herein, wherein the register message is a session initiation protocol (SIP) message.

Example 10 includes the method of example 9 or some other example herein, further comprising: transmitting the SIP message to a serving-call session control function.

Example 11 includes the method of example 1 or some other example herein, wherein the cipher seed comprises a first two-bit value to indicate whether the encrypted message is transmitted to a user equipment (UE) or a proxy-call session control function (P-CSCF) and whether a transmitter of the encrypted message is serving a server role or a client role.

Example 12 includes the method of example 11 or some other example herein, wherein said generating the salt value comprises: concatenating the two-bit value with 30 least-significant bits of the derived key.

Example 13 includes the method of example 11 or some other example herein, wherein said generating the salt value comprises: performing an XOR operation based on the two-bit value and 32 least-significant bits of the derived key.

Example 14 includes a method comprising: generating a first salt value for a first Internet protocol security (IPsec) security association (SA) based on a first portion of a derived key from a key derivation function; generating a second salt value for a second IPsec SA based on a second portion of the derived key; generating first and second nonces based on the first and second salt values, respectively; and generating first and second encrypted messages based on the first and second nonces, respectively.

Example 15 includes the method of example 14 or some other example herein, wherein the first portion of the derived key comprises a first 32-bit portion of the derived key and the second portion of the derived key comprises a second 32-bit portion of the derived key Example 16 includes the method of example 14 or some other example herein, wherein generating the first salt value comprises: generating the first salt value based on the first portion of the derived key and a two-bit value.

Example 17 includes the method of example 15 or some other example herein, wherein the two-bit value is to identify the first portion of the derived key from a plurality of portions of the derived key.

Example 18 includes a method comprising: generating a derived key based on a plurality of input parameters, wherein a first input parameter of the plurality of input parameters is based on a string representing destination; generating a salt value based on the derived key; generating a nonce based on the salt value and an initialization vector; and generating an encrypted message based on the nonce and a pair of encapsulating security payload (ESP) encryption keys.

Example 19 includes the method of example 18 or some other example herein, further comprising: concatenating the string representing destination with a static American Standard Code for Information Interchange (ASCII)-encoded string to generate the first input parameter.

Example 20 includes the method of example 18 or some other example herein, wherein the string representing destination corresponds to a client port of a UE, a server port of a UE, a client port of a proxy-call session control function (P-CSCF), or a server port of a P-CSCF. Another example may include an apparatus comprising means to perform one or more elements of a method described in or related to any of examples 1-20, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Another example may include an apparatus comprising logic, modules, or circuitry to perform one or more elements of a method described in or related to any of examples 1-20, or any other method or process described herein.

Another example may include a method, technique, or process as described in or related to any of examples 1-20, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-20, or portions thereof.

Another example may include a signal as described in or related to any of examples 1-20, or portions or parts thereof.

Another example may include a datagram, information element, packet, frame, segment, PDU, or message as described in or related to any of examples 1-20, or portions or parts thereof, or otherwise described in the present disclosure.

Another example may include a signal encoded with data as described in or related to any of examples 1-20, or portions or parts thereof, or otherwise described in the present disclosure.

Another example may include a signal encoded with a datagram, IE, packet, frame, segment, PDU, or message as described in or related to any of examples 1-20, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Another example may include a computer program comprising instructions, wherein execution of the program by a processing element is to cause the processing element to carry out the method, techniques, or process as described in or related to any of examples 1-20, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1.-20. (canceled)

21. One or more non-transitory, computer-readable media having instructions that, when executed, cause processing circuitry to:
generate a salt value based on a derived key from a key derivation function and a cipher seed;
generate a nonce based on the salt value and an initialization vector; and
generate an encrypted message based on the nonce and a pair of encapsulating security payload (ESP) keys.

22. The one or more non-transitory, computer-readable media of claim 21, wherein the cipher seed comprises a two-bit value to indicate whether the encrypted message is transmitted to a user equipment (UE) or a proxy-call session control function (P-CSCF) and whether a transmitter of the encrypted message is serving a server role or a client role.

23. The one or more non-transitory, computer-readable media of claim 22, wherein to generate the salt value the processing circuitry is to:
concatenate the two-bit value with 30 least-significant bits of the derived key.

24. The one or more non-transitory, computer-readable media of claim 22, wherein to generate the salt value the processing circuitry is to:
perform an XOR operation based on the two-bit value and 32 least-significant bits of the derived key.

25. The one or more non-transitory, computer-readable media of claim 21, wherein the cipher seed is a security association (SA) security parameter index (SPI).

26. The one or more non-transitory, computer-readable media of claim 25, wherein to generate the salt value the processing circuitry is to:
perform an XOR operation based on 32 least significant bits of the derived key and the SA SPI, wherein the SA SPI is represented as a 32-bit integer.

27. The one or more non-transitory, computer-readable media of claim 25, wherein the salt value is a first salt value for the SA, the derived key is a first derived key, the nonce is a first nonce, and the instructions, when executed, further cause the processing circuitry to:
generate a first string (S_1) based on a first plurality of input parameters;
generate the first derived key based on the first string;
generate a second string (S_2) based on a second plurality of input parameters;
generate a second derived key based on the second string; and
generate a second salt value for the SA based on the second derived key and the SA SPI.

28. The one or more non-transitory, computer-readable media of claim 21, wherein the pair of ESP keys include an ESP encryption key (CK_ESP) and an ESP integrity key (IK_ESP) and the instructions, when executed, further cause the processing circuitry to:
generate the CK_ESP and the IK_ESP by performing an authentication and key agreement (AKA) procedure based on an Internet protocol multimedia (IM) cipher key (CK_IM) and an IM integrity key (IK_IM).

29. The one or more non-transitory, computer-readable media of claim 21, wherein the cipher seed is a nonce.

30. The one or more non-transitory, computer-readable media of claim 29, wherein the nonce is a first nonce, the SA is a first SA, the salt value is a first salt value for the first SA, and the instructions, when executed, further cause the processing circuitry to:
generate a second salt value for a second SA based on a second nonce.

31. The one or more non-transitory, computer-readable media of claim 21, wherein the instructions, when executed, further cause the processing circuitry to:
generate a register message with an identifier to indicate user equipment (UE) support for an encryption algorithm utilizing SA-specific salt-value derivation.

32. The one or more non-transitory, computer-readable media of claim 31, wherein the register message is a session initiation protocol (SIP) message.

33. The one or more non-transitory, computer-readable media of claim 32, wherein the instructions, when executed, further cause the processing circuitry to:
transmit the SIP message to a serving-call session control function.

34. An apparatus comprising:
processing circuitry to:
generate a first salt value for a first Internet protocol security (IPsec) security association (SA) based on a first portion of a derived key from a key derivation function;
generate a second salt value for a second IPsec SA based on a second portion of the derived key;
generate first and second nonces based on the first and second salt values, respectively; and
generate first and second encrypted messages based on the first and second nonces, respectively; and
interface circuitry to communicatively couple the processing circuitry with a component of a device.

35. The apparatus of claim 34, wherein the first portion of the derived key comprises a first 32-bit portion of the derived key and the second portion of the derived key comprises a second 32-bit portion of the derived key.

36. The apparatus of claim 34, wherein to generate the first salt value the processing circuitry is to:
generate the first salt value based on the first portion of the derived key and a two-bit value.

37. The apparatus of claim 35, wherein the two-bit value is to identify the first portion of the derived key from a plurality of portions of the derived key.

38. A method comprising:
generating a derived key based on a plurality of input parameters, wherein a first input parameter of the plurality of input parameters is based on a string representing destination;
generating a salt value based on the derived key;
generating a nonce based on the salt value and an initialization vector; and
generating an encrypted message based on the nonce and a pair of encapsulating security payload (ESP) encryption keys.

39. The method of claim 38, further comprising:
concatenating the string representing destination with a static American Standard Code for Information Interchange (ASCII)-encoded string to generate the first input parameter.

40. The method of claim 38, wherein the string representing destination corresponds to a client port of a UE, a server port of a UE, a client port of a proxy-call session control function (P-CSCF), or a server port of a P-CSCF.
